(19) United States
(12) Patent Application Publication
(10) Pub. No.: US 2017/0205804 A1
(43) Pub. Date: Jul. 20, 2017

(54) NUMERICAL CONTROLLER HAVING BLOCK EXECUTION TIME DISPLAY FUNCTION

(71) Applicant: FANUC CORPORATION, Minamitsuru-gun (JP)

(72) Inventor: Hideki Kuroki, Minamitsuru-gun (JP)

(73) Assignee: FANUC CORPORATION, Minamitsuru-gun (JP)

(21) Appl. No.: 15/401,561

(22) Filed: Jan. 9, 2017

(30) Foreign Application Priority Data
Jan. 14, 2016 (JP) 2016-005163

(51) Int. Cl. G05B 19/4063; G05B 13/02

(52) U.S. Cl. CPC G05B 19/4063; G05B 13/021; G05B 2219/39357

(57) ABSTRACT

A numerical controller controls a machine having at least one axis based on at least one program. The numerical controller includes an actual machining time measuring unit that measures an actual machining time which is an actual time taken for execution of at least one block included in the program and a display unit that generates display data indicating a relation between the block and the actual machining time of the block.

### BACKGROUND OF THE INVENTION

1. Field of the Invention

The present invention relates to a numerical controller having a function of displaying a time taken for execution of a block in a program.

2. Description of the Related Art

An operator who creates or modifies a program to be executed on a numerical controller controlling a machine often confirms that the program operates properly while checking a machining time taken for a process performed by controlling the machine based on the program after creating or modifying the program. As a means for recognizing a machining time, for example, a technique for displaying an execution time of a program or an operation time integrated during automatic operation activation is disclosed in JP 2012-243152 A.

However, in the technique disclosed in JP 2012-243152 A, when the program is reviewed in order to reduce a cycle time, there is no method of recognizing a block in which an actual machining time is taken, and it is difficult to verify the validity of the actual machining time of the block if there is no data serving as a reference indicating an appropriate machining time in each block.

Further, in a multiple-path paths, programs for controlling paths are executed, but it is difficult to easily understand a relation between blocks included in the programs controlling the paths. For this reason, even when there is a part in which aggregation of machining steps on the multiple-path paths can be performed, the operator is unable to recognize a part in which aggregation can be performed in each program and likely to extend the cycle time consequently.

### SUMMARY OF THE INVENTION

In this regard, it is an object of the present invention to provide a numerical controller, which is capable of easily detecting the validity of an actual machining time of each block of a program.

A numerical controller according to the present invention controls a machine having at least one axis based on at least one program, and includes an actual machining time measuring unit that measures an actual machining time which is an actual time taken for execution of at least one block included in the program and a display unit that generates display data indicating a relation between the block and the actual machining time of the block.

The numerical controller may further include a reference machining time calculating unit that calculates a reference machining time which is a theoretical time taken for execution of at least one block included in the program, in which the display unit is configured to generate display data indicating a relation among the block, the actual machining time of the block, and the reference machining time of the block.

The numerical controller may further include a cause specifying unit configured to specify a cause of a difference between the actual machining time and the reference machining time for at least one block included in the program when the difference exceeds a predetermined threshold value set in advance, in which the display unit generates display data indicating a relation among the block, the actual machining time of the block, and the cause.

The machine may include a plurality of paths, the numerical controller may be configured to control the machine based on a program controlling each of the paths, and the display unit may be configured to generate display data indicating a relation between actual machining times of the plurality of paths.

According to the present invention, the operator can understand a block whose actual machining time is likely to be inappropriate based on a difference between the actual machining time and the theoretical value and easily specify a cause based on the cause of the difference.

Further, when it is displayed for a program controlling a multiple-path paths, it is possible to easily understand a relation of blocks between paths and make a contribution to a program improvement for aggregation of processes and reduction of the cycle time.

### BRIEF DESCRIPTION OF THE DRAWINGS

FIG. 1 is a functional block diagram of a numerical controller according to an embodiment of the present invention;

FIG. 2 illustrates a display example of a screen in the numerical controller of FIG. 1;

FIG. 3 is a functional, block diagram of a numerical controller according to another embodiment of the present invention; and

FIG. 4 is an example display of screen in the numerical controller of FIG. 3.

### DETAILED DESCRIPTION OF THE PREFERRED EMBODIMENTS

In a numerical controller of the present invention, an actual machining time which is a time taken for execution of each block included in a program is measured for each block, a theoretical machining time is calculated based on the details of each block, and the measured actual machining time and the calculated theoretical machining time are displayed in a comparable manner.

Further, in the numerical controller of the present invention, for a block in which a difference between the measured actual machining time and the calculated theoretical machining time exceeds a threshold which is set in advance, the details of the block and data (servo data or the like) related to an operation of a machine controlled by the block are analyzed, and the cause of the difference between the actual machining time and the theoretical machining time is specified and displayed.

Furthermore, in the numerical controller of the present invention, fora plurality of programs controlling a multiple-path paths, the actual machining times of the blocks included in the programs controlling the paths are simultaneously displayed on a time basis, and thus a relation of the blocks of the programs executed under control of the paths can be easily understood.

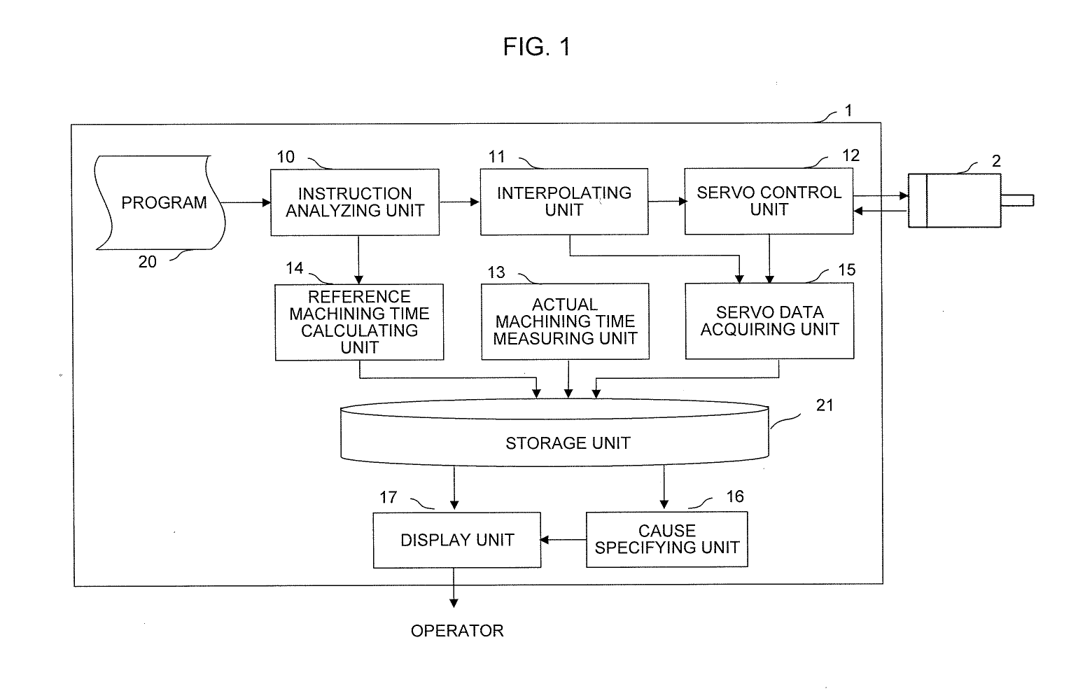

FIG. 1 is a functional block diagram of a numerical controller according to an embodiment of the present invention.

A numerical controller 1 of the present embodiment includes an instruction analyzing unit 10, an interpolating unit 11, the servo control unit 12, the actual machining time measuring unit 13, a reference machining time calculating unit 14, a servo data acquiring unit 15, a cause specifying unit 16, and a display unit 17.

The instruction analyzing unit 10 sequentially reads and analyzes blocks for instructing an operation of a machine serving as a control target from a program 20 stored in a memory (not illustrated), generates instruction data for instructing movement of an axis driven by a servomotor 2 based on an analysis result, and outputs the generated instruction data to the interpolating unit 11. Further, a block serving as an analysis target and the instruction data serving as the block analysis result are outputted to the reference machining time calculating unit 14.

Based on the instruction data received from the instruction analyzing unit, the interpolating unit 11 generates interpolation data as a point at each interpolation period on an instruction path by the instruction data, performs an adjustment of a speed of each axis at each interpolation period for the generated interpolation data (an acceleration/deceleration process), and then outputs the adjusted interpolation data at each interpolation period to the servo control unit 12, as a position instruction A for instructing a position (a movement amount) of the servomotor 2, for each interpolation period.

The servo control unit 12 controls the servomotor 2 which drives the axis of the machine serving as the control target based on the position instruction A received from the interpolating unit 11. The servo control unit 12 sequentially acquires servo data indicating position feedback B of the servomotor 2 when controlling the servomotor 2.

The actual machining time measuring unit 13 measures an actual machining time Tr which is a time taken for execution of a block for each block included in a program 20 when the program 20 is executed, and stores the measured actual machining time Tr in a storage unit 21 in association with each block. As a method of measuring the actual machining time Tr of each block, for example, a method of acquiring the instruction data outputted from the instruction analyzing unit 10 or the interpolation data output from the interpolating unit 11 to the servo control unit 12 and the servo data including data related to the position of the servomotor 2 that the servo data acquiring unit 15 acquires from the servo control unit 12, detecting control start and end points based on each block, and using a difference between a time of the control start point and a time of the control end point based on each block acquired from a timer (not illustrated) as the actual machining time Tr may be used.

The reference machining time calculating unit 14 calculates a reference machining time Tb which is a theoretical machining time of each block based on the block received from the instruction analyzing unit 10 and the instruction data serving as the analysis result of the block, and stores the reference machining time Tb in the storage unit 21 in association with the block.

An example of the reference machining time calculated by the reference machining time calculating unit 14 is an absence-of-acceleration/deceleration reference machining time Tbₙₐ calculated based on a movement distance of each block and an instruction speed. The absence-of-acceleration/deceleration reference machining time Tbₙₐ is a simple estimation time in which an acceleration/deceleration time is not considered and can be calculated by the following Formula (1). In Formula (1), a movement distance L is a movement amount of an axis instructed by an instruction of the block, and an instruction speed F is a moving speed of an axis instructed by an instruction of the block. The operator can confirm influence of the acceleration/deceleration process in the interpolating unit 11 based on a difference between the absence-of-acceleration/deceleration reference machining time Tbₙₐ and the actual machining time Tr.

$${Tb}_{na} = \frac{Movement distance L}{Instruction speed F} \qquad ( 1 )$$

where Tbₙₐ is an absence-of-acceleration/deceleration reference machining time.

As another example of the reference machining time calculated by the reference machining time calculating unit 14, there is an presence-of-acceleration/deceleration reference machining time Tbₐ which is calculated by the technique disclosed in above-described JP 2012-243152 A or a machining time prediction process calculated by a simulation device, or the like.

The reference machining time calculating unit 14 may calculate a plurality of types of above-described reference machining times Tb for each block and store the reference machining times Tb in the storage unit 21 in association with the block.

The servo data acquiring unit 15 acquires the servo data including the position instruction A which the servo control unit 12 receives from the interpolating unit 11 and the position feedback B of the servomotor 2 sequentially acquired from the servomotor 2 from the servo control unit 12 and stores the acquired servo data in the storage unit 21 in association with each block. For example, the servo data acquired by the servo data acquiring unit 15 may be stored in the storage unit 21 in association with (a plurality of pieces of) servo data acquired at intervals of interpolation periods or unit times for each block so that displacement of the position of the servomotor 2 with respect to a time change can be detected.

When there is a difference between the actual machining time and the reference machining time, the cause specifying unit 16 specifies a cause of the difference based on the actual machining time Tr, the reference machining time Tb (the absence-of-acceleration/deceleration reference machining time Tbₙₐ and the presence-of-acceleration/deceleration reference machining time Tbₐ), and the servo data, which are stored in association with each block included in the program 20, through the reference machining time calculating unit 14, the actual machining time measuring unit 13, and the servo data acquiring unit 15.

The cause specifying unit 16 first obtains a difference between the actual machining time Tr and the reference machining time Tb, and when the obtained difference is larger than a predetermined certain threshold value, the cause specifying unit 16 specifies the block as a block having a difference between the actual machining time Tr and the reference machining time Tb. As an example of the threshold value, a time threshold value and a ratio threshold value may be considered. In the case in which the time threshold is used, when the difference between the actual machining time Tr and the reference machining time Tb is larger than the time threshold, the block may be specified as a block having a difference between the actual machining time Tr and the reference machining time Tb. In the case in which the ratio threshold is used, when the following Formula (2) is satisfied, the block may be specified as a block having the difference between the actual machining time Tr and the reference machining time Tb.

$$\frac{\vert Tr - Tb \vert}{Tb} \times 100 > ratio threshold \qquad ( 2 )$$

When a plurality of reference machining times such as the absence-of-acceleration/deceleration reference machining time Tbₙₐ and the presence-of-acceleration/deceleration reference machining time Tbₐ are recorded as described above, the cause specifying unit 16 preferably specify a block having a difference with the presence-of-acceleration/deceleration reference machining time Tbₐ.

Then, the cause specifying unit 16 analyzes data related to the specified block having the difference between the actual machining time Tr and the reference machining time Tb and specifies the cause of the difference.

When the block having the difference is an auxiliary function such as M (an auxiliary function), S (a spindle speed function), T (a tool function), or B (a second auxiliary function), the cause of the difference is specified by analyzing a corresponding function. Unlike a movement instruction of a G code or the like, a time taken for operation of each auxiliary function based on an instruction greatly changes according to a situation, and thus the operation of each auxiliary function may be the cause of the difference. As examples of the cause of the difference, when the instruction is a standby instruction with another paths, a “waiting M code with another paths” is the cause, and when the instruction is a tool exchange instruction, a “tool function based on a T code” is the cause.

On the other hand, when the block having the difference is a feed instruction such as a rapid traverse instruction (G00) or a cutting feed instruction (G01), the cause of the difference is specified by analyzing the servo data stored in the storage unit 21 in association with the block. The servo data includes the position instruction A which the servo control unit 12 receives from the interpolating unit 11 and the position feedback B of the servomotor 2 which is sequentially acquired from the servomotor 2 as described above and is stored in the storage unit 21 in association with each block.

For example, the cause specifying unit 16 compares the instruction speed F of the block serving as the analysis target and a position instruction speed A′ (a differential value of the position instruction A) calculated by the following Formula (3) using the same unit based on the servo data. Then, when the position instruction speed A′ calculated by Formula (3) does not reach the instruction speed F instructed in the block at least once during control in the block, the fact that “the instruction speed is not reached” is specified as the cause of the difference.

$$Position instruction speed {A}^{′} = \frac{dA}{dt} \qquad ( 3 )$$

Further, the cause specifying unit 16 calculates an error amount C based on the difference between the position instruction A and the position feedback B of the servomotor 2 included in the servo data, and when the calculated error amount C is larger than a threshold of an allowable error amount which is set in advance, “delay caused by servo followability” is specified as the cause of the difference.

The display unit 17 generates display data for displaying the actual machining time Tr stored in the storage unit 21 in association with each block, the reference machining time Tb, and the difference between the actual machining time Tr and the reference machining time Tb of each block calculated by the cause specifying unit 16, the cause of the difference between the actual machining time Tr and the reference machining time Tb of each block, and the like, and causes the display data to be displayed on a display device (not illustrated).

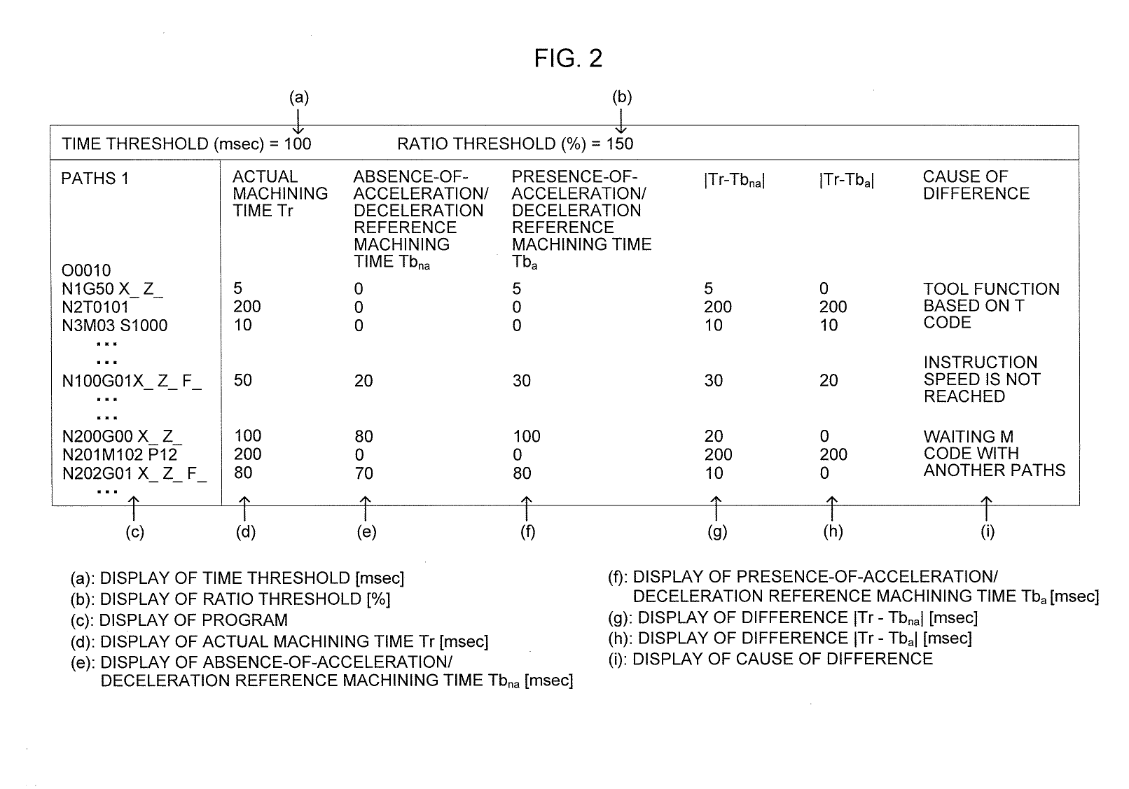

FIG. 2 illustrates an example of a screen in which the display data generated by the display unit 17 is displayed on the display device.

In the screen example of FIG. 2, the actual machining time Tr, the absence-of-acceleration/deceleration reference machining time Tbₙₐ and the presence-of-acceleration/deceleration reference machining time Tbₐ which serve as the reference machining time Tb, the difference between the actual machining time Tr and the reference machining time, and the cause of the difference are displayed together with a corresponding block. Through such a display, the operator can understand a block whose actual machining time is likely to be inappropriate based on the difference between the actual machining time and the theoretical value for each block and easily specify the cause based on the cause of the difference.

The display data generated by the display unit 17 need not include all of the above-mentioned data, and only some pieces of the data may be displayed according to the purpose of the operator. For example, when the actual machining time Tr and the reference machining time Tb are displayed together, the operator can sufficiently understand the validity of the actual machining time of each block of the program. Further, only the cause of the difference may be displayed without displaying the difference. Furthermore, a graph indicating a change in the error amount C may be displayed beside each block, or any other display item may be displayed together.

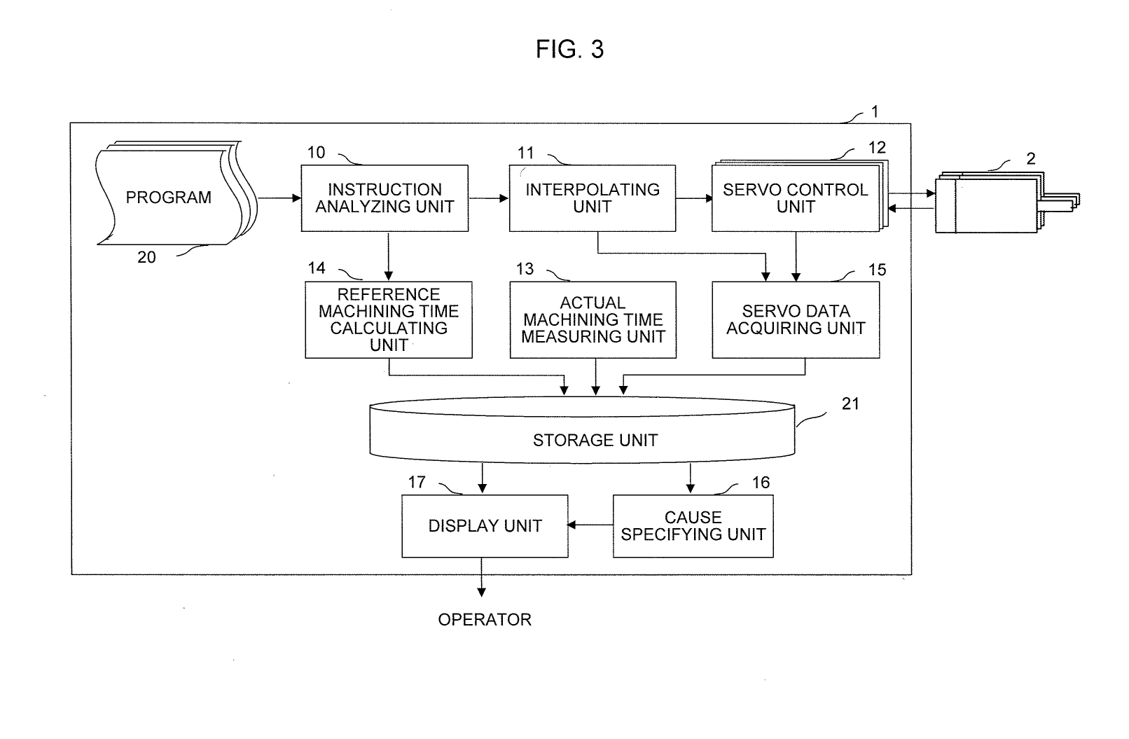

FIG. 3 is a functional block diagram of the numerical controller when the multiple-path paths of the present invention is controlled.

The numerical controller 1 of this embodiment is different from the numerical controller 1 illustrated in FIG. 1 in that a plurality of servomotors 2 each of which drives each path and a plurality of servo control units 12 each of which controls each servomotor 2 are provided. Further, the instruction analyzing unit 10, the interpolating unit 11, the actual machining time measuring unit 13, the reference machining time calculating unit 14, and the servo data acquiring unit 15 may be prepared in each path.

The instruction analyzing unit 10 of the present embodiment sequentially reads and analyzes blocks which instructs an operation of the machine serving as the control target from each program 20 that controls each path stored in a memory (not shown), generates instruction data of each path for instructing movement of an axis driven by the servomotor 2 of each path based on an analysis result, and outputs the generated instruction data of each path to the interpolating unit 11. Further, the instruction analyzing unit 10 outputs the block of each path set as the analysis target and the instruction data serving as the analysis result of the block to the reference machining time calculating unit 14.

The interpolating unit 11 generates the interpolation data of each path, as a point at each interpolation period on the instruction path, by the instruction data based on the instruction data of each path received from the instruction analyzing unit, performs an adjustment of a speed of each axis at each interpolation period with respect to the generated interpolation data of each path (an acceleration/deceleration process), and then outputs the adjusted interpolation data for each interpolation period to the servo control unit 12 of each path as the position instruction A for instructing the position (the movement amount) of the servomotor 2 at each interpolation period.

The servo control unit 12 controls the servomotor 2 of each path which drives the axis of the machine of each path serving as the control target based on the position instruction A received from the interpolating unit 11. The servo control unit 12 sequentially acquires the servo data indicating the position feedback B of the servomotor 2 when controlling the servomotor 2 of each path.

The actual machining time measuring unit 13 measures the actual machining time Tr which is a time taken for execution of a block for each block included in the program 20 of each path when the program 20 is executed, and stores the measured actual machining time Tr in the storage unit 21 in association with each block of each program. A method of measuring the actual machining time Tr through the actual machining time measuring unit 13 is similar to that in the embodiment illustrated in FIG. 1.

The reference machining time calculating unit 14 calculates the reference machining time Tb which is a theoretical machining time of each block of the program of each path based on the block of the program of each path received from the instruction analyzing unit 10 and the instruction data being the analysis result of the block, and stores the calculated reference machining time Tb in the storage unit 21 in association with the block of each program. A method of calculating the reference machining time Tb through the reference machining time calculating unit 14 is similar to that in the embodiment illustrated in FIG. 1.

The servo data acquiring unit 15 acquires the servo data including the position instruction A which the servo control unit 12 of each path receives from the interpolating unit 11 and the position feedback B of the servomotor 2 of each path sequentially acquired from the servomotor 2 of each path from the servo control unit 12 of each path and stores the acquired servo data in the storage unit 21 in association with each block of the program of each path. A method of acquiring the servo data through the servo data acquiring unit 15 is similar to that in the embodiment illustrated in FIG. 1.

When there is a difference between the actual machining time and the reference machining time, the cause specifying unit 16 specifies the cause of the difference based on the actual machining time Tr, the reference machining time Tb (the absence-of-acceleration/deceleration reference machining time Tbₙₐ and the presence-of-acceleration/deceleration reference machining time Tbₐ), and the servo data, which are stored in association with each block included in the program 20 of each path, through the reference machining time calculating unit 14, the actual machining time measuring unit 13, and the servo data acquiring unit 15. A method of calculating the difference between the actual machining time and the reference machining time and specifying the cause of the difference through the cause specifying unit 16 is similar to that in the embodiment illustrated in FIG. 1.

The display unit 17 generates display data for displaying the actual machining time Tr stored in the storage unit 21 in association with each block, the reference machining time Tb, and the difference between the actual machining time Tr and the reference machining time Tb of each block included in each program 20 of each path calculated by the cause specifying unit 16, the cause of the difference between the actual machining time Tr and the reference machining time Tb of each block included in each program 20 of each path, and the like, and causes the display data to be displayed on a display device (not illustrated).

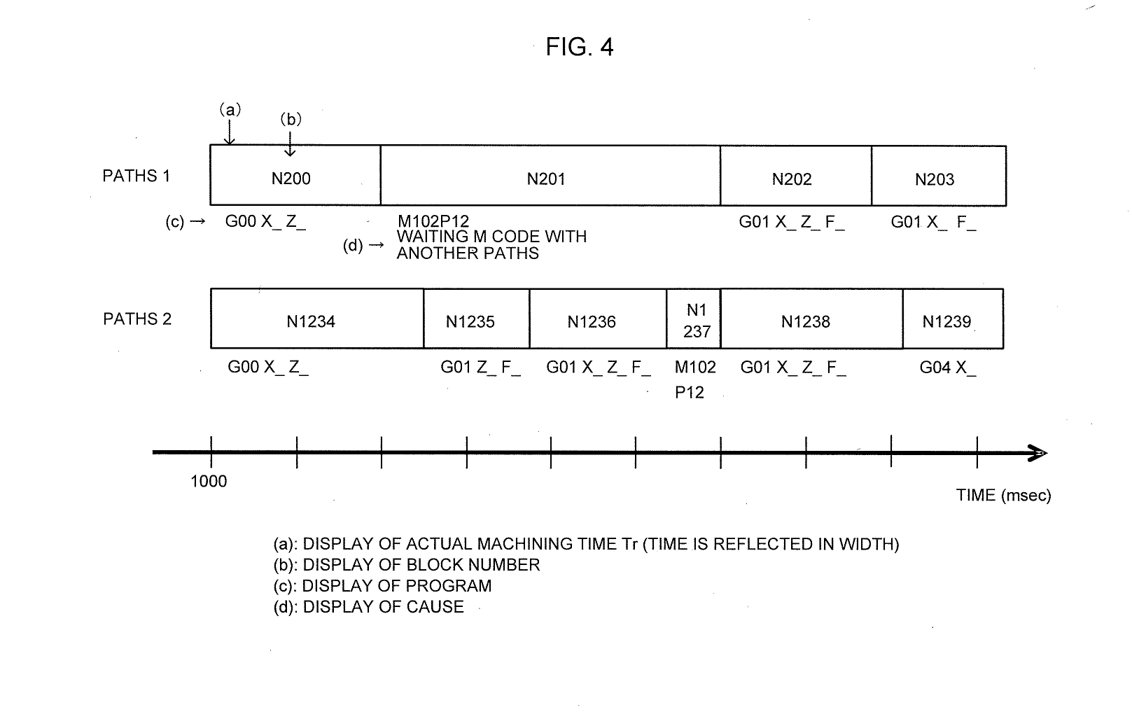

FIG. 4 illustrates an example of a screen in which the display data generated by the display unit 17 is displayed on the display device. In the example of FIG. 4, the actual machining time Tr which is taken for execution of each block of the program of each path is indicated by a box having a width corresponding to the length of the actual machining time Tr, and each path is indicated in a manner such that boxes are connected in the right direction in order from the first block of the program and displayed. A block number of a corresponding block is displayed on each box, and an instruction given by a corresponding block and the cause of the difference of the actual machining time Tr and the reference machining time Tb are displayed below the box. Further, the respective paths are vertically displayed side by side to be aligned with a time axis at the time of execution. Based on such display, the operator can easily understand a temporal relation of blocks between paths and make a contribution to a program improvement for aggregation of processes and reduction of the cycle time.

The display data generated by the display unit 17 need not include all of the above-mentioned items, and only some pieces of the data may be displayed according to the purpose of the operator. Further, the reference machining time Tb of each path may be displayed together below the display of each path in a display manner similar to the display of the actual machining time described above. Furthermore, it is also possible to display any other display item together.

The embodiment of the present invention has been described above, but the present invention is not limited to the example of the above-described embodiment, and the present invention can be carried out in various forms through appropriate modifications.

For example, in the above-described embodiment, the calculation of the reference machining time Tb by the reference machining time calculating unit 14 has been described as being performed at the same time as execution of the program, but the calculation of the reference machining time Tb need not be performed at the same time as execution of the program, and the reference machining time Tb of each block of the program may be calculated in advance and stored in the storage unit 21 in association with each block.

Further, in the above-described embodiment, an example in which display is performed so that the relation between each block of the program and the actual machining time and reference machining time of the block can be understood and another example in which display is performed so that the relation between the actual machining times of the blocks of the programs of the paths can be understood have been described, but the numerical controller 1 may be configured so that switching between these two types of displays can be performed.

1. A numerical controller controlling a machine having at least one axis based on at least one program, comprising:
an actual machining time measuring unit configured to measure an actual machining time being an actual time taken for execution of at least one block included in the program; and
a display unit configured to generate display data indicating a relation between the block and the actual machining time of the block.

2. The numerical controller according to claim 1, further comprising,
a reference machining time calculating unit configured to calculate a reference machining time being a theoretical time taken for execution of at least one block included in the program,
wherein the display unit is configured to generate display data indicating a relation among the block, the actual machining time of the block, and the reference machining time of the block.

3. The numerical controller according to claim 2, further comprising,
a cause specifying unit configured to specify a cause of a difference between the actual machining time and the reference machining time for at least one block included in the program when the difference exceeds a predetermined threshold value set in advance,
wherein the display unit generates display data indicating a relation among the block, the actual machining time of the block, and the cause.

4. The numerical controller according to claim 1,
wherein the machine includes a plurality of paths,
the numerical controller is configured to control the machine based on a program controlling each of the paths, and
the display unit is configured to generate display data indicating a relation between actual machining times of the plurality of paths.
